(19) United States
(12) Patent Application Publication
(10) Pub. No.: US 2020/0141698 A1
(43) Pub. Date: May 7, 2020

(54) PRACTICAL APPROACH FOR MULTI-OBJECT DETECTION, DATA ASSOCIATION, AND TRACKING

(71) Applicant: BAE SYSTEMS Information and Electronic Systems Integration Inc., Nashua, NH (US)

(72) Inventors: Quang M. LAM, Fairfax, VA (US); Michael J. CHOINIERE, Merrimack, NH (US); David A. RICHARDS, Merrimack, NH (US)

(73) Assignee: BAE SYSTEMS Information and Electronic Systems Integration Inc., Nashua, NH (US)

(21) Appl. No.: 16/178,842

(22) Filed: Nov. 2, 2018

(51) Int. Cl. F41G 5/08; G01S 17/02; F41H 7/02; H04N 5/33

(52) U.S. Cl. CPC F41G 5/08; H04N 5/33; F41H 7/02; G01S 17/023

(57) ABSTRACT

A multiple target tracking, data association, and track file management system (MTT, DA, and TFM) specifically developed for a ground based EO/IR camera proposed in this present disclosure is intended for three main purposes: (1) providing a ground-based combat vehicle with multiple mission capability by adding a new low cost EO/IR sensor with MTT, DA, and TFM functionalities built-in to interact with the ground-based fire control and command guidance for both surface-to-surface and surface-to-air defense missions; (2) serving as a plug-and-play integrated sensor with built-in MTT functionalities easily adaptable to be used for other missions; (3) part of the weapon GN&C subsystem to function in a smart fashion allowing projectiles to work in a collaborative engagement fashion.

### FIELD OF THE DISCLOSURE

The present disclosure relates to the data association function in complex multiple target detection and tracking applications and more particularly to processing multiple measurements from an EO/IR camera for multiple targets tracking (MTT) and maintaining their respective track files in a cohesive manner.

### BACKGROUND OF THE DISCLOSURE

The multiple targets tracking (MTT) problem and its data association (DA) algorithms (i.e., nearest neighbor (NN), multiple hypotheses tracking (MHT), or joint probability data association (JPDA)) are well known in the sensors fusion and MTT community. However, MTT solutions suitable for an onboard weapon's guidance and control interactions, especially for closed-loop tracking accuracy needed in order to guide multiple weapons to intercept multiple desired targets in a low cost and computational less intensive manner are rarely available.

Wherefore it is an object of the present disclosure to achieve a closed-loop MTT and track file management system using a practical and simplified implementation approach allowing an on-board Guidance and Control (G&C) subsystem to timely close the respective loops (i.e., weapon/target pairing rate) for successful engagements of multiple targets to overcome the above-mentioned shortcomings and drawbacks associated with the conventional multi-object guidance systems.

### SUMMARY OF THE DISCLOSURE

It has been recognized that multiple target tracking (MTT) using either a single sensor or multiple sensors to detect and track multiple targets deployed in various domains (i.e., space, air, ground, or maritime) is effective for an Intelligence, Surveillance, and Reconnaissance (ISR) mission. However, for an on-board weapon system, an MTT used as part of the integrated Guidance, Navigation, and Control (GNC) scheme must provide the onboard weapon with the ability to pinpoint what the weapon can see in the context of multiple track files, and determine how the data can be used to assist the weapon to accomplish its end goal which is to acutely pair the tracking such that a projectile is guided to a collision course with an appropriate target via an active target track.

One aspect of the present disclosure is a simple MTT solution suitable as an on-board MTT system capable of producing the MTT functionalities (i.e. measurements to track association and track file management) while offering effective MTT performance without incurring MTT design complexity.

One embodiment of the system provides a self-contained MTT solution per sensor which is directly ready for interfacing and interacting with the on-board GN&C subsystems to achieve a closed loop engagement mission.

One aspect of the present disclosure is an improved tracking, targeting, and guidance system, comprising: at least one sensor installed on a vehicle, wherein the sensor is part of a fire control subsystem (FCS); the sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to a guidance system to complete an engagement: process images from the at least one sensor in real-time; detect one or more target location measurements for one or more targets using the images from the at least one sensor to produce potential target tracks; process the one or more target location measurements to determine if the one or more target location measurements from the at least one sensor are correlated with predicted target tracks via the fire control system, if not, then uncorrelated target tracks are placed in a separate file for possible new target track initiation/creation; associate the potential target tracks via a gating system, wherein potential target tracks falling within a gating threshold are chosen as active target tracks; update and maintain active target tracks as part of a track file management (TFM) system, as target state estimates for individual targets; feed output from the track file management (TFM) system to a weapon target assignment system to calculate a correct acceleration profile to guide a projectile onto a collision course with the one or more targets by pairing the correct active target track with one or more targets.

One embodiment of the improved tracking, targeting, and guidance system is wherein the sensor is an EO/IR camera. The vehicle can be a land based vehicle such as a tank, armored carrier, and the like. In a further example the vehicle is sea based such as a frigate, destroyer, cruiser amphibious vehicle, submarine and the like. The vehicle in a further example is air based such as an unmanned aerial vehicle (UAV), drone, helicopter, fighter aircraft and the like.

Another embodiment of the improved tracking, targeting, and guidance system is wherein the target is on the ground. In some cases, the target is in the air.

Yet another embodiment of the improved tracking, targeting, and guidance system is wherein the uncorrelated target tracks are declared as clutters and no new track is initiated or created if the new measurements do not persist across continuous samples.

Another embodiment of the improved tracking, targeting, and guidance system is wherein if the potential target tracks do not satisfy the gating criterion they are rejected in real time as part of a clutter rejection mechanism. In some cases, if target tracks created in the track file management (TFM) system have not received continuous measurement updates for more than three consecutive samples, the tracks are deleted.

Still yet another embodiment of the improved tracking, targeting, and guidance system is wherein an active track file management (TFM) system contains all active tracks.

Another aspect to the present disclosure is a method of data association in a multi-projectile/multi target system, comprising: processing images from at least one sensor mounted on a vehicle in real-time, wherein the sensor is part of a fire control subsystem (FCS), the at least one sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to a guidance system to complete an engagement; detecting one or more target location measurements for one or more targets using the images from the at least one sensor to produce potential target tracks; processing the one or more target location measurements to determine if the one or more target location measurements from the at least one sensor are correlated with predicted target tracks via the fire control system, if not, then uncorrelated target tracks are placed in a separate file for possible new target track initiation/creation; associating the potential target tracks via a gating system, wherein the potential target tracks that fall within a gating threshold are chosen as active target tracks; updating and maintaining the active target tracks as part of a track file management (TFM) system, as target state estimates for individual targets; feeding output from the track file management (TFM) system to a weapon target assignment system; pairing an active target track with a correct target; and calculating via a guidance system a correct acceleration profile to guide a projectile onto a collision course with the correct target.

One embodiment of the method of data association in a multi-projectile/multi target system is wherein the at least one sensor is an EO/IR camera. In some cases, the vehicle is a tank.

Another embodiment of the method of data association in a multi-projectile/multi target system is wherein the target is on the ground. In some cases, the fire control system is configured to perform surface-to-surface and/or surface-to-air missions.

Yet another embodiment of the method of data association in a multi-projectile/multi target system is wherein the uncorrelated target tracks are declared as clutters and no new track is initiated or created if the new measurements do not persist across continuous samples.

Still yet another embodiment of the method of data association in a multi-projectile/multi target system is wherein if the potential target tracks do not satisfy the gating threshold they are rejected in real-time as part of a clutter rejection mechanism.

In certain embodiments, if active target tracks created in the track file management (TFM) system have not received continuous measurement updates for more than three consecutive samples, the tracks are deleted.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a diagrammatic view of one embodiment of a multi-object tracking and guidance system according to the principles of the present disclosure.

FIG. 2 is a diagrammatic view of one embodiment of the measurement to track (MTT) fusion function of the present disclosure.

FIG. 3A is a flowchart showing one embodiment of extended Kalman filter (EKF) data association according to the principles of the present disclosure.

FIG. 3B is a diagram of one embodiment of the data association (DA) and track file (TF) development according to the principles of the present disclosure.

FIG. 4 is a diagram of one embodiment of a real-time, on board, multi-target track system using a global nearest neighbor (GNN) approach to data association (DA).

FIG. 5 is a diagram of one embodiment of a real-time, on board, multi-target track system using a global nearest neighbor (GNN) approach to data association (DA) with a focus on the target state estimation module.

FIG. 6 shows a plot of eight potential targets, with six of the targets flagged to be hit, where multiple measurements of multiple targets are processed by one embodiment of the function and operation according to the principles of the present disclosure.

FIG. 7 shows a plot of eight potential targets, with six of the targets flagged to be hit, where multiple measurements of multiple targets are processed by one embodiment of the function and operation according to the principles of the present disclosure.

FIG. 8 shows a flowchart of one embodiment of a method according to the principles of the present disclosure.

### DETAILED DESCRIPTION OF THE DISCLOSURE

In one embodiment of the present disclosure, a system is provided to handle the data association problem caused by multiple measurements collected by multiple sensors (e.g., EO/IR or RF seeker) in a multiple targets/multiple projectiles operating situation. In some cases, multiple guided projectiles are used to address various target types. As used herein, bullets, rockets, missiles and other precision guided munitions are generally considered projectiles. In these applications, it is imperative that the precision guided munitions are associated with the correct objects being tracked. Otherwise, the state estimate of these multiple objects will not be consistently maintained to accurately support a Fire Control System (i.e., supplying the correct state vector to the guidance systems of each projectile in real-time for the effective ordering of engagement with the correct targets).

One aspect of this disclosure is a new data association function that matches the correct measurements to the correct tracks for real-time track update, maintenance, and management, thus solving the data association problem with a high probability of correct matching of measurements to tracks in a closely-spaced, multi-target situation. While many technical publications present the multi-targets/multi-sensors tracking problem; practical designs to accomplish high performance in the context of measurements to track association in the presence of object maneuvering uncertainties and closely spaced objects has not been seen.

The ability to maintain multiple track files in a cohesive manner while supplying their state vectors at a highly reliable and accurate level are important for the situational awareness, threat assessment, and on-board or off-board command guidance subsystems. This allows the projectiles to engage with the correct type of targets/threats based on either in-flight target update or onboard decision-making processing.

The present disclosure offers dynamic track files of respective multiple targets signatures by processing multiple target measurements collected by an EO/IR camera (either mounted on a vehicle or on-board a weapon platform) and sending those track files to projectiles' guidance subsystems to assign targets and complete the engagement process.

It is understood that Precision Guided Munitions (PGMs) need to have a practical track file management system to maintain precise object (i.e., multiple projectile and multiple target) state estimate vectors so that they can effectively and timely support the order of engagement when interfacing with G&C subsystems. Some mainstream multiple target tracking (MTT) algorithms (i.e., Global Nearest Neighbor Filter (GNNF) and its variants, Multiple Hypothesis Tracker (MHT) based design and its variants, Joint Probability Hypothesis Data Association (JPDA) filter and its variants) are deemed to be suitable for an ISR mission but not to be used as an onboard MTT feeding the G&C subsystems the correct track file in a cohesive manner. The table below illustrates the self-contained data association and track file management features of one embodiment of the present disclosure developed for a single EO/IR sensor mounted on a tank detecting and tracking multiple targets (either ground-based or air-based). There, multiple target track files (target state estimates) are provided to the on-board guidance and control subsystems for successful engagements of respective targets assigned to the weapon via the weapon to target assignment (WTA).

The following table represents one embodiment of a top level summary of the main multiple target tracking (MTT) and track file management (TFM) function (MTT_DA_TFM.m).

```
function [P_k_new, X_k_new, ekf_out, track_out, e_out = MTT_DA_TFM
(P_k, X_k, y_k, Q, R, dT,
random_ind)
%% MTT, Data Association, and Track File Management Function
%%%%%%(MTT_DA_TFM.m) for an EO/IR camera′s multiple
measurements y
%% Parameters
gateLevel = 0.5*pi/180;% 0.5 deg gating function for the EO/IR meas.
[trackNum, state] = size(X_k);
[nMeas, sizeMeas] = size(y_k);
track_out = zeros(trackNum, 2);
[^{~}, sort_ind] = sort(random_ind);
track_out(:,1) = sort_ind;
temp_ind = zeros(trackNum,1);
e_out = zeros(trackNum,2);
%% 1) Allocate memory for MTT_DA_TFM Processor
% initialize parameters for current time step
X_k_new = zeros(size(X_k));
P_k_new = zeros(size(P_k));
Z_k = zeros(size(X_k));
G_EKF_comp = zeros(state,sizeMeas,trackNum);
ekf_out = zeros(size(X_k));
DistM = 1000*ones(trackNum,nMeas); % TrackNum and number of
measure are the same in our case
res = ones(trackNum,nMeas,sizeMeas);
% Main Loop
for i = 1:trackNum
  X_in = X_k(i,:)′;
  P_in = P_k(:,:,i);
  y_in = y_k(i,:)′;
  [X_out, P_out, y_p, S, K, Z_out] = AO_ekf(X_in, P_in, Q, R, dT, y_in);
% Angle Only (AO) EKF Using a Mixed Coordinate System (MCS)
  X_k_new(i,:) = X_out′;
  P_k_new(:,:,i) = P_out;
  Z_k(i,:) = Z_out′;
  G_EKF_comp(:,:,i) = K;
ekf_out(i,:) = X_out′;
%% 3) Statistical Distance & Residual
  for j = 1:nMeas
    y_m = y_k(j,:)':
    if any(y_m)
      fovCount = fovCount + 1;
      [DistM(i,j), res(i,j,:)] = gaussian_prob(y_m, y_p, S, 2); % i is track
      index, j is valid data index
    end
  end
end
for i = 1:trackNum
  e_out(i,:) = squeeze(res(i,sort_ind(i),:));
end
%% 4) Apply Gate Threshold
DistLabels = DistM < gateLevel;% Gate satisfaction criterion
%% 5) Track Assignment
for i = 1:trackNum
ValidAssociatedInd = find(DistLabels(i,:));
  if ^{~}isempty(ValidAssociatedInd) % if pass the threshold test
    if numel(ValidAssociatedInd) > 1
      [^{~}, midx] = min(DistM(i,ValidAssociatedInd));
      % Reduce ValidAssociatedInd to one with minimum label
      ValidAssociatedInd = ValidAssociatedInd(midx);
    end
    temp_ind(i) = ValidAssociatedInd;
%% 6) Propogate Estimated State Based on Track Assignment
    K = G_EKF_comp(:,:,i);
    e = squeeze(res(i,ValidAssociatedInd,:));
    Z_temp = Z_k(i,:) + K*e; % update predicted state estimate (n × 1)
    X_k_temp = f_x(Z_temp);
    X_k_new(i,:) = X_k_temp';
  end
end
track_out(:,2) = temp_ind;
end
%%%% The rest of the functions called by the Main Function,
MTT_DA_TFM.m
```

In certain embodiments of the present disclosure, an effective method of keeping the state estimate vectors of respective multiple targets driving the guidance subsystem for proper order of engagement execution has been demonstrated. In some embodiments, measurements to track association and track file management infrastructure defined in the above table have been effectively carried out for this ground based mission's fire control sensor definition.

Specific applications of this present disclosure are threefold: (1) the MTT system is self-contained for installation on a ground-based vehicle's (e.g., a tank) fire control system (FCS) to operate independently/individually or to operate as a team; (2) the MTT system provides the ground-based FCS precision MTT track files of multiple targets for the guidance subsystem to process to complete the order of engagement; and (3) the MTT system is robust enough to handle EO/IR angle only measurements.

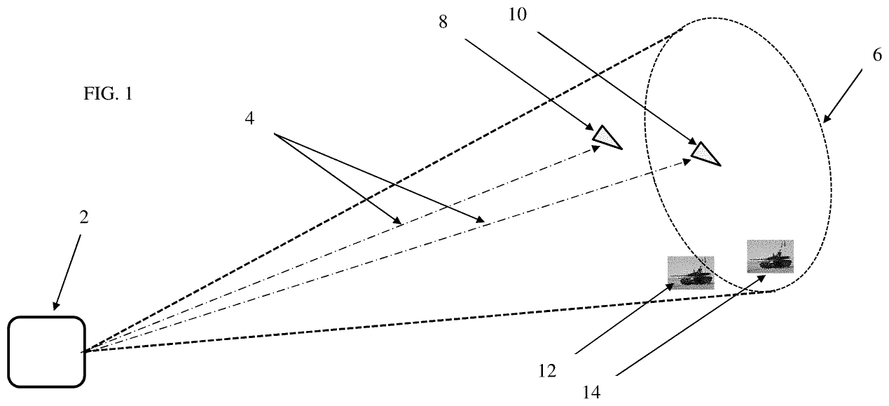

Referring to FIG. 1, a diagrammatic view of one embodiment of a multi-object tracking and guidance system according to the principles of the present disclosure is shown. More specifically, in this embodiment multiple sensors are colocated on a ground vehicle 2 (e.g., a tank). In some embodiments, the two sensors are an EO/IR sensor and an RF sensor as targeting sensor and bullet tracking sensor, respectively. The EO/IR sensor has a wide field of view 6 capable of capturing multiple targets measurements (i.e., multiple targets 12, 14) while the RF sensor is used to detect and track multiple projectiles 4. The MTT algorithms proposed in this present disclosure are employed to process measurements (multiple targets and multiple projectiles) from these respective sensors to produce high precision bullet state estimators (BSE) and target state estimators (TSE). Then the multiple projectiles are matched with the appropriate multiple targets according to an order of engagement of a Fire Control System, or the like.

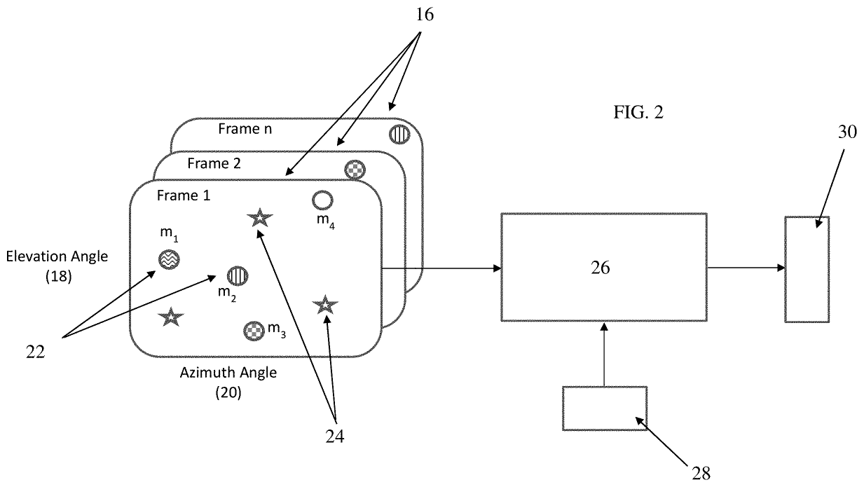

Referring to FIG. 2, one embodiment of the measurement to track (MTT) fusion function of the present disclosure is shown in diagrammatic form. More specifically, from frame to frame 16, the measurement mᵢ (22) vs clutters (24) appear in different locations or coordinates (i.e., [az₁, elᵢ], i=1,2, . . . n). The target tracker under a typical multiple measurements situation is not able to pair or associate which measurements belong to which actual target's state vector for accurate track updating. In some cases, if a wrong measurement is used to update a track on the filter side, that track would not be confirmed and would be deleted in the MTT processing sequence for track maintenance and management.

Still referring to FIG. 2, one embodiment of the present disclosure is intended to address the measurements origin uncertainty common to multi-object situations by comparing the seeker/sensor measurements against predicted measurements (of respective tracks) for gating and associating the correct measurement with the correct track. In one embodiment, this is accomplished via minimal error comparison using a selected gating algorithm 28, i.e., the MTT_DA_TFM algorithm captured in the Table above. In certain embodiments, this is referred to as a measurement to track (MTT) fusion function 26. As shown in the various frames 16 the elevation angle 18 and azimuth angle 20 for each individual clutter 24 and each individual object of interest 22 is shown changing position from frame to frame. Once the information is fed into the measurement to track fusion function 26 according to a particular gating function 28, the data is input into an EKF-based track prediction and management module.

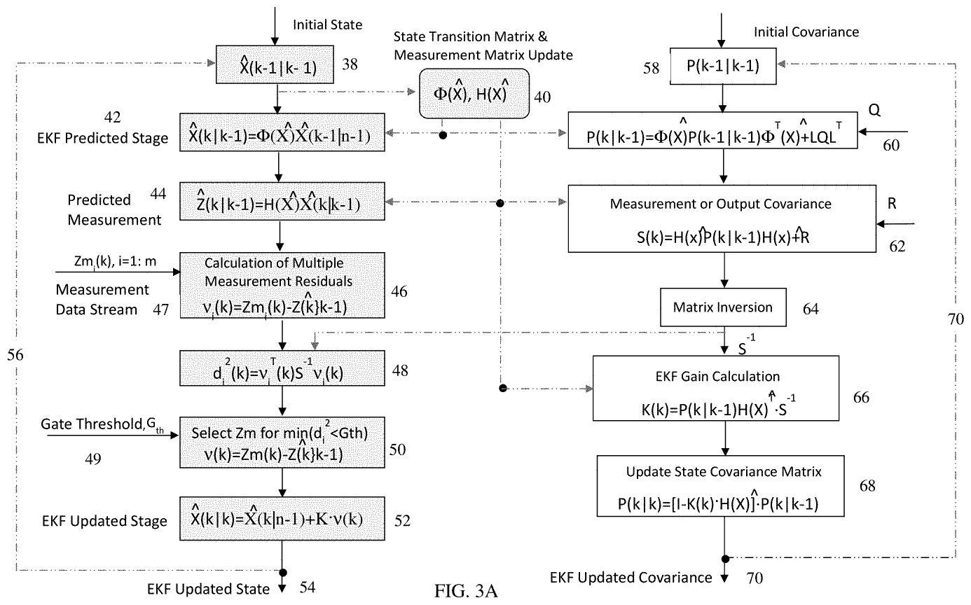

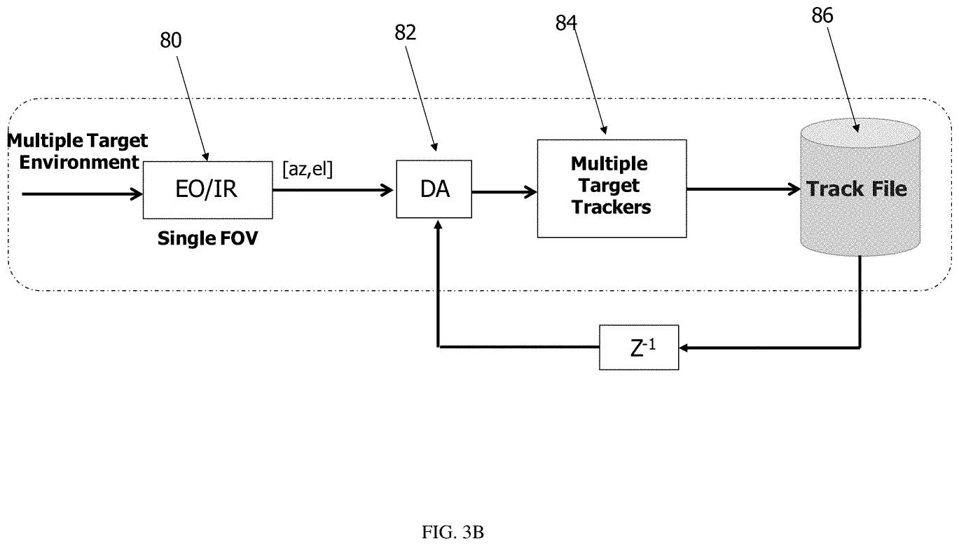

Referring to FIG. 3A, a flowchart of one embodiment of extended Kalman filter (EKF) data association (DA) according to the principles of the present disclosure is shown. More specifically, the data association in this embodiment is via a MTT_DA_TFM. The entire figure represents the EKF processing cycle including the gating process according to one embodiment of the present disclosure, where each EKF will be properly initialized for each new track and/or target.

On the left side of FIG. 3A the state vector is addressed, and on the right side of the figure the covariance is addressed. More specifically, at the top left, the initial state vector is input 38 and is run through a state transition matrix and measurement matrix update module 40. This module feeds into an EKF predicted stage for the state 42 and for the covariance 60. The state transition matrix and measurement matrix update module 40 also feeds data into the predicted measurement for the state 44 and the covariance 62. Additionally, the state transition matrix and measurement matrix update module 40 is fed into the EKF gain calculation 66 for the covariance calculations.

Once the predicted state measurement 44 is completed, it will be used to compare against the multiple targets measurements data stream 47 for respective multiple residuals calculations 46. These multiple residuals (i.e., the individual target state estimation errors, predicted vs current track estimate) from all measurements against all existing tracks will be compared against a selected gating threshold 49 to complete the data association and measurement to track association functions. The residual distance squared d² 48 is used in gating 50, where the gating threshold 49 uses distance squared 48 against each EKF as individual target matching for data association. In one embodiment, the gate threshold Gₜₕ 49 there is one satisfied residual (within threshold) used for the state update. The EKF update stage 52 uses a satisfied residual for state update 54. That Updated state is then utilized for the initial state 38 for a subsequent iteration 56.

Still referring to FIG. 3A, on the right hand side of the diagram, the state covariance matrix is computed for the propagated and updated stages for time state propagation and measurement update, respectively. The initial covariance is input 58 and static process noise (Q) 60 and measurement noise (R) 62 covariance matrices are employed as part of the covariance and EKF gain calculation process. A matrix inversion 64 is completed and is input into an EKF calculation 66 which is used for an updated covariance matrix 68. The resulting EKF updated covariance 68 is then utilized for the initial covariance 58 for a subsequent iteration 70.

Referring to FIG. 3B, a diagram of one embodiment of the data association (DA) and track file development according to the principles of the present disclosure is shown. More specifically, the process occurs in a multiple target environment using one or more seekers 80 having one or more fields of view (FOV). The EO/IR sensor 80 provide azimuth, elevation angles measurements data to the data association (DA) module 82. Using a practical based multiple target tracker module 84 provides an updated track file 86. During development, the track to track fusion was matched with truth target files to validate the solutions and perfect the design of the system.

Still referring FIG. 3B, for gating design and validation, two closely spaced targets (1 and 2) were used along with a widely spaced target 3. The gating design was based on the EKF measurement residual vector of all measurements against all active tracks in the track file. vᵢ(k)=Zmᵢ(k)−\hat{Z}j(k) where \hat{Z}j(k)=H·K and \hat{Z}j(k) is the predicted [azimuth, elevation] angles computed from EKF's Cartesian TSE state vector (i.e., predicted position from two angles)) and Zmᵢ(k) is the EO/IR camera's [azimuth, elevation] angles. The validation test implies the measurements z(k+1) are distributed according to Gaussian distribution, centered at the measurement prediction \hat{z}(k+1) with covariance S(k+1). Skipping time indices p(z)=N_{z} (\hat{z}, S), this assumption is also called measurement likelihood model. Then, with d²=V^{T}S⁻¹V being the squared Mahalanobis distance of a pairing, measurements will be in the area V(γ)={z: d²≤γ} with a probability defined by gate threshold γ. This area is known as the validation gate. In certain embodiments, γ can be shaped as spherical, ellipsoid, or rectangular gate.

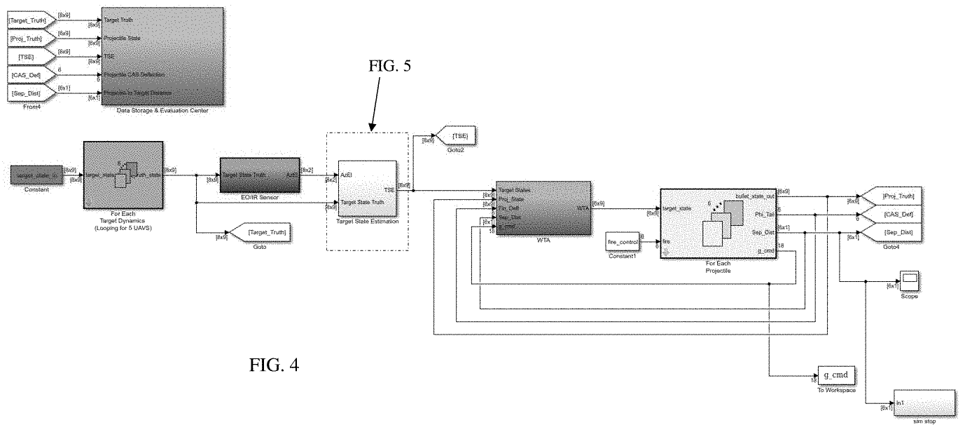

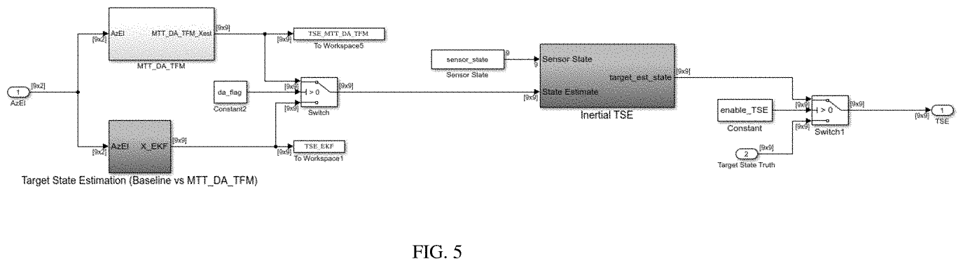

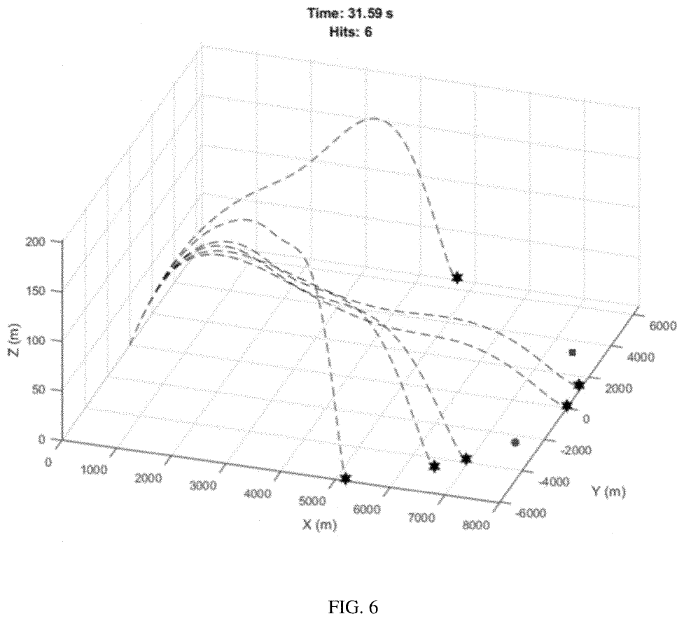

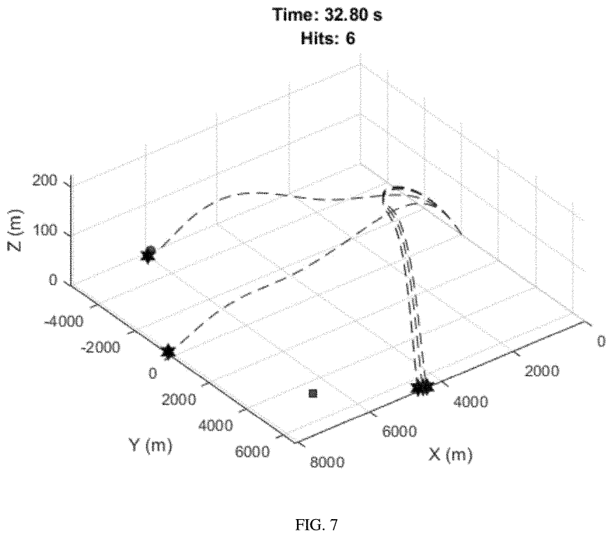

Referring to FIG. 4 and FIG. 5, a diagram of one embodiment of a real-time, on board, multi-target track system using a modified nearest neighbor (MNN) approach to data association (DA), i.e., Multiple Target Tracking, Data Association, and Track File Management (MTT_DA_TFM) with a focus on the target state estimation module is shown. The algorithmic description of this MTT_DA_TFM function is captured in the Table above. This functional block is integrated into the overall many on many engagement missions whose performance results are illustrated in FIG. 6 and FIG. 7.

Referring to FIG. 6, a plot of eight potential targets, with six of the targets selected to be engaged via the WTA (weapon target assignment), using the precision multiple tracks produced using the principles of the present disclosure is shown. More specifically, these eight targets are closely spaced with one another; however, their respective tracks accuracies are managed and kept at a precision level allowing the WTA algorithm to successfully carry out its assignment function to fulfill a many-on-many engagement mission. In some contexts, a single sensor and multiple closely spaced targets environment the effectiveness of the proposed MTT_DA_TFM function has been tested. Data association and track file management accuracy is precise enough to allow the WTA to carry out its function to achieve a successful many-on-many engagement mission.

Referring to FIG. 7, a plot of eight potential targets, with six of the targets flagged to be hit, where multiple measurements of multiple targets are processed by one embodiment of the function and operation according to the principles of the present disclosure is shown. More specifically, engagement testing was completed with very closely spaced targets. See, e.g., a false target at Z=0 m, Y=−6000 m and X=6000 m.

The proposed MTT, DA, and TFM software functionalities are integrated into an EO/IR sensor (and applicable to any other active sensors) turning these sensors into plug-and-play units serving multiple missions. Multiple mission include ground-based, sea-based, air-based, or even space-based. These have been practically evaluated using a high fidelity engagement simulation.

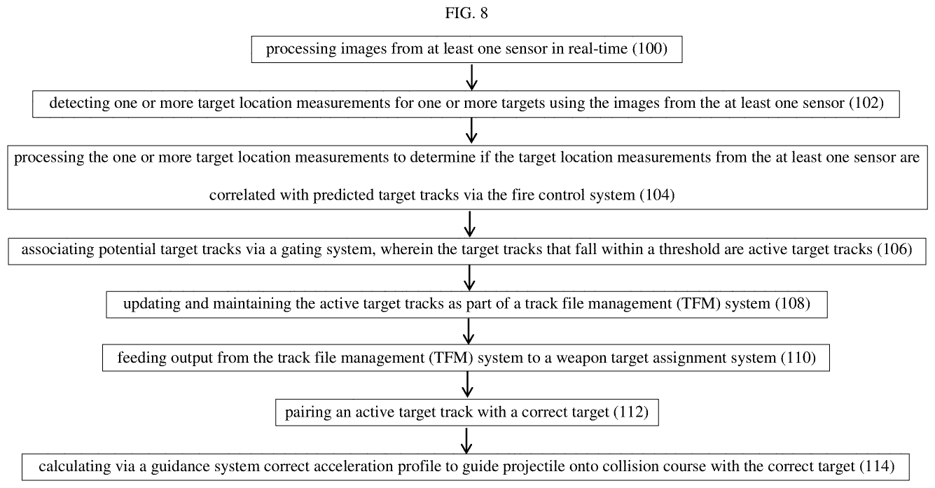

Referring to FIG. 8, one embodiment of a method according to the principles of the present disclosure is shown. More particularly, in a multi-projectile/multi-target mission there is a need to correctly associate each projectile with the correct target for successful completion of a mission. To begin, images from at least one sensor located on a vehicle are processed in real-time 100. One or more target location measurements are detected for one or more targets using the images from the at least one sensor to produce potential target tracks 102. The one or more target location measurements are processed to determine if the one or more target location measurements from the at least one sensor are correlated with predicted target tracks via the fire control system 104. If not, then uncorrelated target tracks are placed in a separate file for possible new target track initiation/creation. The potential target tracks are then associated via a gating system, wherein the potential target tracks that fall within a gating threshold are chosen as active target tracks 106. The active target tracks are updated and maintained over time as part of a track file management (TFM) system 108. The TFM produces target state estimates for each individual target. Output from the track file management (TFM) system is fed to a weapon target assignment system 110. Each active target track is paired with a correct target 112. A guidance system then calculates a correct acceleration profile to guide a projectile onto a collision course with the correct target 114.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be auto-coded and embedded into an advanced chip based processor or FPGA to address a large target population for a single integrated picture compilation serving situational awareness purpose for traffic monitoring and alert actions implemented in software as an application program tangible embodied on a computer readable program storage device. The software can be used to serve ground, air, or space traffic monitoring and management system with appropriate modifications. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. An improved tracking, targeting, and guidance system, comprising:
at least one sensor installed on a vehicle, wherein the sensor is part of a fire control subsystem (FCS);
the sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to a guidance system to complete an engagement:
process images from the at least one sensor in real-time;
detect one or more target location measurements for one or more targets using the images from the at least one sensor to produce potential target tracks;
process the one or more target location measurements to determine if the one or more target location measurements from the at least one sensor are correlated with predicted target tracks via the fire control system, if not, then uncorrelated target tracks are placed in a separate file for possible new target track initiation/creation;
associate the potential target tracks via a gating system, wherein potential target tracks falling within a gating threshold are chosen as active target tracks;
update and maintain active target tracks as part of a track file management (TFM) system, as target state estimates for individual targets;
feed output from the track file management (TFM) system to a weapon target assignment system to calculate a correct acceleration profile to guide a projectile onto a collision course with the one or more targets by pairing the correct active target track with one or more targets.

2. The improved tracking, targeting, and guidance system according to claim 1, wherein the at least one sensor is an EO/IR camera.

3. The improved tracking, targeting, and guidance system according to claim 1, wherein the vehicle is a tank.

4. The improved tracking, targeting, and guidance system according to claim 1, wherein the target is on the ground.

5. The improved tracking, targeting, and guidance system according to claim 1, wherein the fire control system is configured to perform surface-to-surface and/or surface-to-air missions.

6. The improved tracking, targeting, and guidance system according to claim 1, wherein the uncorrelated target tracks are declared as clutters and no new track is initiated or created if the new measurements do not persist across continuous samples.

7. The improved tracking, targeting, and guidance system according to claim 1, wherein if the potential target tracks do not satisfy the gating threshold they are rejected in real-time as part of a clutter rejection mechanism.

8. The improved tracking, targeting, and guidance system according to claim 1, wherein if active target tracks created in the track file management (TFM) system have not received continuous measurement updates for more than three consecutive samples, the tracks are deleted.

9. The improved tracking, targeting, and guidance system according to claim 1, wherein an active track file management (TFM) system contains all active target tracks.

10. A method of data association in a multi-projectile/multi target system, comprising:
processing images from at least one sensor mounted on a vehicle in real-time, wherein the sensor is part of a fire control subsystem (FCS), the at least one sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to a guidance system to complete an engagement;
detecting one or more target location measurements for one or more targets using the images from the at least one sensor to produce potential target tracks;
processing the one or more target location measurements to determine if the one or more target location measurements from the at least one sensor are correlated with predicted target tracks via the fire control system, if not, then uncorrelated target tracks are placed in a separate file for possible new target track initiation/creation;
associating the potential target tracks via a gating system, wherein the potential target tracks that fall within a gating threshold are chosen as active target tracks;
updating and maintaining the active target tracks as part of a track file management (TFM) system, as target state estimates for individual targets;
feeding output from the track file management (TFM) system to a weapon target assignment system;
pairing an active target track with a correct target; and
calculating via a guidance system a correct acceleration profile to guide a projectile onto a collision course with the correct target.

11. The method of data association in a multi-projectile/multi target system according to claim 10, wherein the at least one sensor is an EO/IR camera.

12. The method of data association in a multi-projectile/multi target system according to claim 10, wherein the vehicle is a tank.

13. The method of data association in a multi-projectile/multi target system according to claim 10, wherein the target is on the ground.

14. The method of data association in a multi-projectile/multi target system according to claim 10, wherein the fire control system is configured to perform surface-to-surface and/or surface-to-air missions.

15. The method of data association in a multi-projectile/multi target system according to claim 10, wherein the uncorrelated target tracks are declared as clutters and no new track is initiated or created if the new measurements do not persist across continuous samples.

16. The method of data association in a multi-projectile/multi target system according to claim 10, wherein if the potential target tracks do not satisfy the gating threshold they are rejected in real-time as part of a clutter rejection mechanism.

17. The method of data association in a multi-projectile/multi target system according to claim 10, wherein if active target tracks created in the track file management (TFM) system have not received continuous measurement updates for more than three consecutive samples, the tracks are deleted.
